(19) United States
(12) Patent Application Publication
(10) Pub. No.: US 2021/0295617 A1
(43) Pub. Date: Sep. 23, 2021

(54) ACCOMMODATION AREA MANAGEMENT DEVICE

(71) Applicant: HONDA MOTOR CO., LTD., Tokyo (JP)

(72) Inventors: Gaku SHIMAMOTO, Saitama (JP); Junpei NOGUCHI, Saitama (JP); Yuta TAKADA, Tokyo (JP); Ryoma TAGUCHI, Tokyo (JP); Shogo KOBAYASHI, Saitama (JP)

(73) Assignee: HONDA MOTOR CO., LTD., Tokyo (JP)

(21) Appl. No.: 17/204,378

(22) Filed: Mar. 17, 2021

(30) Foreign Application Priority Data
Mar. 19, 2020 (JP) 2020-050296

(51) Int. Cl. G07C 5/08; G08G 1/14

(52) U.S. Cl. CPC G07C 5/0808; G08G 1/148

(57) ABSTRACT

A parking lot management device which manages a parking lot includes an acquisition unit, a determination unit and a processor. The acquisition unit acquires vehicle information regarding a status of the vehicle. The determination unit determines whether or not maintenance of the vehicle is necessary based on the vehicle information acquired by the acquisition unit. The processor sets a target parking position of the vehicle based on the determination result by the determination unit. When the maintenance of the vehicle is unnecessary, the processor sets a first parking position as the target parking position, and when the maintenance of the vehicle is necessary, the processor sets a second parking position as the target parking position.

### CROSS-REFERENCE TO RELATED APPLICATIONS

The present application claims the benefit of priority of Japanese Patent Application No. 2020-050296, filed on Mar. 19, 2020, the content of which is incorporated herein by reference.

### TECHNICAL FIELD

The present invention relates to an accommodation area management device that manages an accommodation area capable of accommodating a moving body.

### BACKGROUND

Recently, there is a technique related to a moving body utilization system for enabling a user who is not the owner of a moving body to use the moving body for a predetermined purpose (see, for example JP-A-2019-075039). When receiving a use application for a user who is not the owner of a vehicle as a moving body to use the vehicle for a predetermined purpose, according to the use application, an instruction fir the user to use the vehicle is transmitted to the vehicle. The vehicle moves to the user who applied for the use according to the instruction described above.

### SUMMARY

However, in the technique of the related art, a technique for smoothly connecting a moving body used by a user to the next use is not sufficiently studied. In particular, after a user who is not the owner of the moving body uses the moving body, the behavior of the moving body at the accommodation area is not sufficiently studied.

The present embodiment provides an accommodation area management device which smoothly connects a moving body accommodated in an accommodation area to the next use, thus enabling effective utilization of the moving body

An aspect of the present embodiment is an accommodation area management device which manages an accommodation area that accommodates a moving body and stops the moving body at one of a plurality of accommodation positions provided in the accommodation area, the device comprising:
an acquisition unit which acquires stop reservation information regarding a reservation for stopping the moving body in the accommodation area from a terminal device of a user of the moving body or the moving body; and
a stop management unit which sets one of the plurality of accommodation positions as an accommodation position for stopping the moving body according to the scheduled stop time of the moving body in the accommodation area based on the stop reservation information acquired by the acquisition unit, wherein
the accommodation area is divided into a plurality of partial accommodation areas, each having one or more accommodation positions, and
the stop management unit sets an accommodation position included in the partial accommodation area corresponding to the scheduled stop time among the plurality of partial accommodation areas as an accommodation position for stopping the moving body.

According to the present embodiment, it is possible to smoothly connect a moving body accommodated in an accommodation area to the next use, thus enabling effective utilization of the moving body.

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device.

FIG. 3 is a diagram illustrating an example of a configuration of the parking lot management device.

FIG. 4 is a diagram illustrating an example of a parking space status table.

FIG. 5 is a diagram illustrating an example of a vehicle information table.

FIG. 6 is a flowchart illustrating a series of processing flows of the parking lot management device.

### DESCRIPTION OF EMBODIMENTS

Hereinafter, an embodiment of an accommodation area management device of the present invention will be described with reference to the accompanying drawings. In the following embodiment, an example will be described in which a moving body in the present invention is a vehicle and an accommodation area in the present invention is a parking lot. Further, in the following embodiment, an example in which the accommodation area management device of the present invention is used as a parking lot management device for managing a parking lot will be described.

### Vehicle System

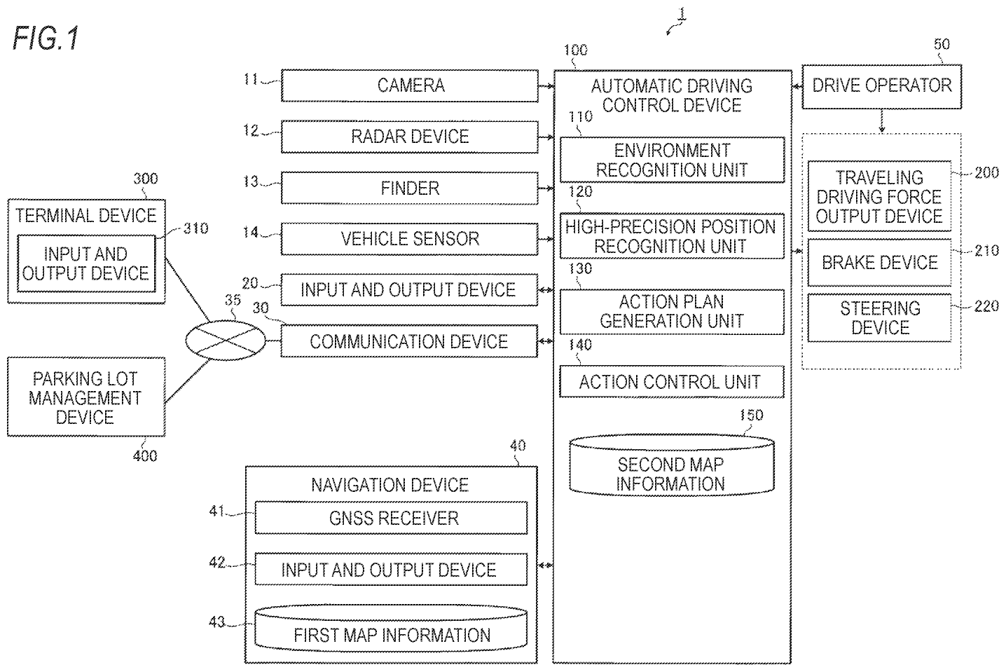

First, a vehicle of the embodiment will be described. In FIG. 1, a vehicle system 1 is mounted on a vehicle having an automatic driving function of a so-called automatic driving level “4” or higher. A vehicle (hereinafter, also referred to as vehicle M) equipped with the vehicle system 1 is a vehicle including a drive source (for example, traveling driving force output device 200 described below) and wheels (for example, two wheels, three wheels, or four wheels) including driving wheels driven by the power of the drive source. The drive source of the vehicle M is, for example, an electric motor. Further, the drive source of the vehicle M may be an internal combustion engine such as a gasoline engine or a combination of an electric motor and an internal combustion engine.

As illustrated in FIG. 1, the vehicle system 1 includes a camera 11, a radar device 12, a tinder 13, a vehicle sensor 14, an input and output device 20, a communication device 30, a navigation device 40, a drive operator 50, an automatic driving control device 100, the traveling driving force output device 200, a brake device 210, and a steering device 220. Each of those devices is communicably connected to each other by a wired or wireless communication network. The communication network connecting each of those devices is, for example, Controller Area Network (CAN).

The camera 11 is a digital camera which photographs the periphery (for example, in front of vehicle M) of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of vehicle M) of the vehicle M, and outputs the detection result to the automatic driving control device 100.

The finder 13 is, for example, Laser Imaging Detection and Ranging (LIDAR). The tinder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication intensity) of the radio wave used by the communication device 30. described later, for communication. The vehicle sensor 14 outputs the detection result of each sensor to the automatic driving control device 100 or like.

The input and output device 20 includes an output device which outputs various kinds of information to a user of the vehicle M and an input device which accepts various input operations from the user of the vehicle M. The output device of the input and output device 20 is, for example, a display which displays based on a processing result of the automatic driving control device 100. The output device may be a speaker, a buzzer, an indicator light, or the like. Further, the input device of the input and output device 20 is, for example, a touch panel or an operation button (key, switch, or the like) which outputs an operation signal corresponding to an input operation received from a user to the automatic driving control device 100.

The communication device 30 is connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carried by a user of the vehicle M, a parking lot management device 400 which manages a parking lot PA where the vehicle M can be parked. The terminal device 300 is, for example, a srnartphone or a tablet terminal and is an electronic device connected to the network 35 and including an input and output device 310. The input and output device 310 is, for example, a display which displays various information to a user, a touch panel which accepts a user's input operation, and the like. The parking lot PA and the parking lot management device 400 will be described below.

The navigation device 40 includes a Global Navigation Satellite System (GNSS) receiver 41 and an input and output device 42. Further, the navigation device 40 includes a storage device (not illustrated) such as a flash memory, and first map information 43 is stored in this storage device. The first map information 43 is, for example, information representing a road shape by a link indicating a road and a node connected by the link. Further, the first map information 43 may include information representing the curvature of the road and the Point Of Interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user of the vehicle M and an input device which accepts various input operations from a user of the vehicle M. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

For example, the navigation device 40 determines a route (hereinafter, also referred to as a route on the map) from the position of the vehicle M specified by the GNSS receiver 41 to a destination input by the user with reference to the first map information 43. Then, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by the function of the terminal device 300. Also, for example, the communication device 30 may transmit the information indicating the position of the vehicle M and the destination input by a user to a server device (navigation server) outside the vehicle system 1, and the function of the navigation device 40 may be realized by this server device.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210 and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor.

The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction of the steering wheels.

### Automatic Driving Control Device

The automatic driving control device 100 includes an environment recognition unit 110. a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from the parking lot management device 400. Then, the automatic driving control device 100 updates the second map information 150 so as to incorporate the received in-parking-lot map information into the second map information 150. As a result, the automatic driving control device 100 can specify the position of each parking space in the parking lot PA with reference to the second map information 150.

The environment recognition unit 110 performs sensor fusion processing on information acquired by a part or all of the camera 11, the radar device 12 and the finder 13 in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processor (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processor (GPU), and for example, the storage device for storing the second map information 150 and the high-precision position recognition unit 120 may be realized by a Map Positioning nit (MPU). Further, a part or all of the functional units of the automatic driving control device 100 may be realized by the cooperation of software and hardware.

### Parking Lot Managed by Parking Lot Management Device

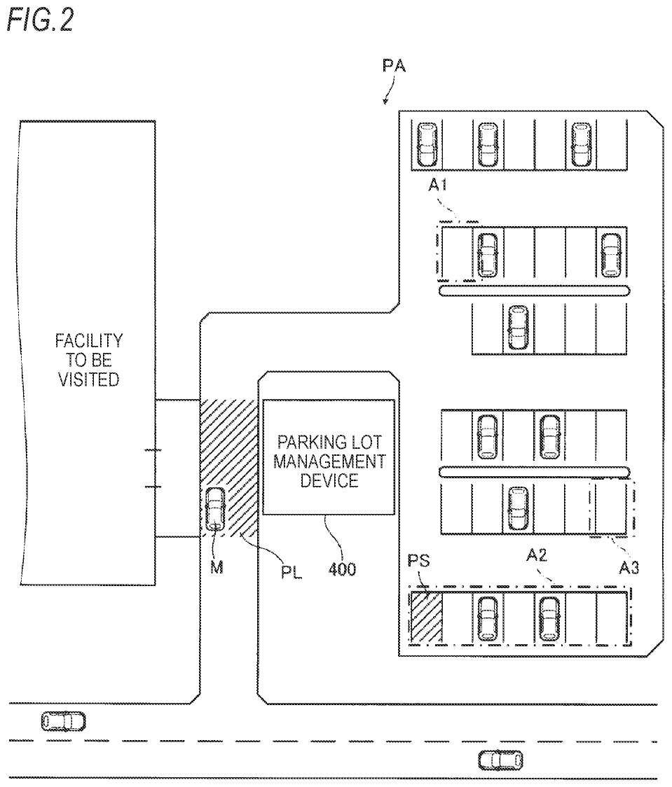

Next, an example of the parking lot PA will be described with reference to FIG. 2. As illustrated in FIG. 2, the parking lot PA is a parking lot managed by the parking lot management device 400, and is an automatic valet parking type parking lot attached to a visited facility to be visited by a user. The parking lot PA includes a plurality of parking spaces PS where a vehicle (for example, vehicle M) can be accommodated and a platform PL provided right before the plurality of parking spaces PS. Hereinafter, an example in which a user of the vehicle M uses the parking lot PA will be described.

Before using the parking lot PA, the user of the vehicle M uses the terminal device 300, the navigation device 40, and the like to make a reservation for using the parking lot PA to the parking lot management device 400 which manages the parking lot PA. For example, the user of the vehicle M inputs date and time of using the parking lot PA and identification information of the vehicle M into the terminal device 300 and sends the information to the parking lot management device 400, so that the reservation for using the parking lot PA is made. After that, at the reserved date and time of use, the user of the vehicle M rides the vehicle M on the platform PL and gets off from the vehicle M at the platform PL.

After the user gets off the vehicle M, the vehicle M automatically drives and starts a self-propelled parking event to move to any parking space PS in the parking lot PA. For example, the user uses the terminal device 300 to send a request to start the self-propelled parking event to the parking lot management device 400. In response to this start request, the parking lot management device 400 instructs the vehicle M to perform the self-propelled parking event to park the vehicle M in a predetermined parking space PS. According to this instruction, the vehicle M moves to the parking space PS instructed by the parking lot management device 400 while being guided with the parking lot management device 400 and performing sensing with the camera 11, the radar device 12, the finder 13, or the like. As a result, the vehicle M is parked in the parking space PS instructed by the parking lot management device 400 as the parking position.

In addition, the vehicle M can carry out re-parking, so-called “reparking”, in which the parking position is changed to another parking position while the vehicle M is parked in the parking lot PA. This reparking is appropriately carried out by an instruction from the parking lot management device 400 or by voluntary automatic driving by the vehicle M itself.

In addition, at the time of exit of the vehicle M, the vehicle M performs automatic driving and performs a self-propelled parking event to move from the parking space PS to the platform PL. For example, the user uses the terminal device 300 to send a request to start the self-propelled parking event to the parking lot management device 400. In response to this start request, the parking lot management device 400 instructs the vehicle M to perform the self-propelled parking event for moving the vehicle M from the parking space PS where the vehicle M is parked to the platform PL. According to this instruction, the vehicle M moves to the platform PL while being guided by the parking lot management device 400 or sensing with the camera 11, the radar device 12, the finder 13, or the like. The user of the vehicle M gets on the vehicle M at the platform PL and exits from the parking lot PA.

### Parking Lot Management Device

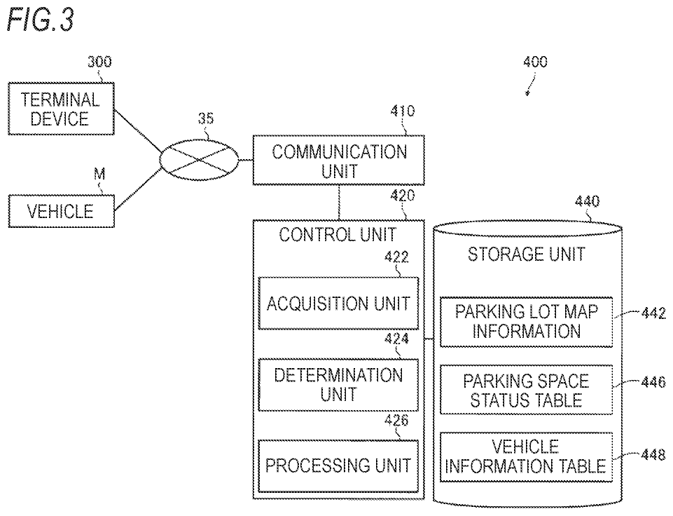

Next, an example of the configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, a determination unit 424, and a processor 426. Each component of the control unit 420 is realized, for example, by a hardware processor such as a CPU executing a program (software). Some or all of those components may be realized by hardware (circuit part: including circuitry) such as LSI, ASIC, FPGA, and GPU or may be realized by collaboration between software and hardware. The program may he stored in advance in a storage device (a storage device including a non-transient storage medium) such as an HDD or a flash memory, or the program may be stored in a removable storage medium (a non-transient storage medium) such as a DVD or a CD-ROM and installed by attaching the storage medium to a drive device.

Information such as parking lot map information 442, a parking space status table 446, and a vehicle information table 448 is stored in the storage unit 440. The storage unit 440 is realized by an HDD, a flash memory, or the like.

The communication unit 410 communicates with the vehicle M or the user's terminal device 300 wirelessly (for example, network 35). The control unit 420 determines the parking space PS to park the vehicle M based on the information acquired by the communication unit 410 and the information stored in the storage unit 440, and guides the vehicle M to the parking space PS. The parking lot map information 442 is information which geometrically represents the structure of the parking lot PA. Further, the parking lot map information 442 includes the coordinates for each parking space PS. Further, the communication unit 410 communicates with the vehicle M entering the parking lot PA or the vehicle M in the parking lot PA, and receives the vehicle information regarding the status of the vehicle M. The vehicle information will be described below.

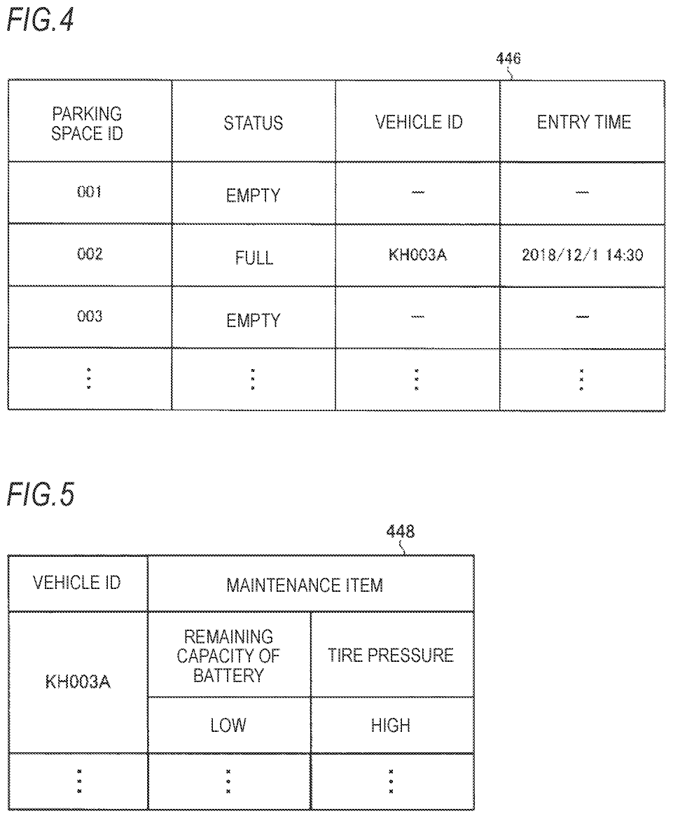

The acquisition unit 422 acquires the position information of the vehicle M already parked in the parking lot PA via the communication unit 410. This position information is stored, for example, in the form of the parking space status table 446. As illustrated in FIG. 4, in the parking space status table 446, for example, information indicating whether the parking space PS is empty or full (parked), the vehicle ID which is the identification information of the parked vehicle M when the parking space PS is full, and the entry time of the vehicle M when the parking space PS is full are associated with the parking space ID which is the identification information of the parking space PS. The entry time is recorded, for example, in association with the vehicle ID of the vehicle M when the vehicle M enters the parking lot PA. The vehicle ID can be, for example, a vehicle number written on a vehicle number plate (so-called license plate).

In addition, the acquisition unit 422 also acquires the position information of the vehicle M traveling in the parking lot PA. The vehicle M traveling in the parking lot PA periodically transmits information associating the vehicle ID of the own vehicle with the position (for example, the position recognized by high-precision position recognition unit 120) of the own vehicle in the parking lot PA, to the parking lot management device 400. The acquisition unit 422 acquires information in which the vehicle ID transmitted from the vehicle M traveling in the parking lot PA and the position in the parking lot PA are associated with each other via the communication unit 410. Further, when the parking lot management device 400 receives the information in which the vehicle ID and the position in the parking lot PA are associated with each other from the vehicle M traveling in the parking lot PA, the parking lot management device 400 may store the received information in a predetermined table of the storage unit 440. Then, the acquisition unit 422 may acquire the position information of the vehicle M traveling in the parking lot PA with reference to this table.

Further, the acquisition unit 422 acquires vehicle information regarding the status of the vehicle M via the communication unit 410. The vehicle information is an example of the moving body information in the present invention. The vehicle information is stored in the format of the vehicle information table 448, for example. As shown in FIG. 5, the vehicle information table 448 stores, for example, the vehicle ID which is the identification information of the vehicle M, and the maintenance item in association with each other.

The maintenance item forms the vehicle information regarding the status of the vehicle M, and indicates, for example, the remaining energy (including remaining battery capacity, remaining gasoline, and the like) and tire pressure. That is, the vehicle information includes information indicating whether or not maintenance is necessary for the vehicle M. For example, the vehicle information indicating that the remaining energy is low (for example, the remaining energy is below a threshold value. In FIG. 5, the remaining energy is shown as “low”) indicates that maintenance to charge the battery of the vehicle M is necessary. Further, for example, the vehicle information indicating that the tire pressure is low (for example, the tire pressure is below a threshold value. In FIG. 5, the tire pressure is shown as “low”) indicates that maintenance to fill the tires of the vehicle M with air is necessary.

The information indicating the remaining energy of the vehicle M and the tire pressure is acquired by various sensors and the like provided in the vehicle M, transmitted, from the vehicle M to the parking lot management device 400 as the vehicle information, and stored in the vehicle information table 448 by, the parking lot management device 400. The vehicle information is not limited to the remaining energy and the tire pressure, but may be information indicating other items (for example, the remaining amount of various oils or the like).

The determination unit 424 determines whether or not maintenance of the vehicle M is necessary, based on the vehicle information acquired by the acquisition unit 422. For example, as described above, the determination unit 424 determines that maintenance of the vehicle M (specifically, maintenance to charge the battery) is necessary, based on the vehicle information acquired by the acquisition unit 422 indicating that the remaining energy is low (for example, the remaining energy is below the threshold value). Further, as described above, the determination unit 424 determines that maintenance of the vehicle M (specifically, maintenance to fill the tires with air) is necessary, based on the vehicle information acquired by the acquisition unit 422 indicating that the tire pressure is low (for example, the tire pressure is below the threshold value).

Note that the parking lot management device 400 may store in advance the information indicating an appropriate value for each vehicle type of the vehicle M for each maintenance item, for example. Then, the determination unit 424 may determine whether maintenance is necessary for the vehicle M (whether there is a maintenance item that deviates from the appropriate value), based on the vehicle information received from the vehicle M and the appropriate value according to the vehicle type of the vehicle M.

The processor 426 sets a target parking position of the vehicle M based on the determination result by the determination unit 424. For example, when the maintenance of the vehicle M is unnecessary, the processor 426 sets a first parking position designated by a general method as the target parking position. On the other hand, when the maintenance of the vehicle M is necessary, the processor 426 sets a second parking position as the target parking position.

For example, when the determination unit 424 determines that the maintenance of the vehicle M is necessary, the processor 426 sets a second parking position A2 shown in FIG. 2 as the target parking position. Here, the second parking position A2 is a parking position used as a maintenance area. Fax example, in each parking space PS included in the second parking position A2, a power supply facility that supplies power to the vehicle M, and a compressor that fills the tires of the vehicle M with air are available. Therefore, by parking the vehicle M determined to require maintenance at the second parking position A2, it is possible to arrange an environment for maintenance of the vehicle M.

Further, for example, when the determination unit 424 determines that the maintenance of the vehicle M is unnecessary, the processor 426 sets a first parking position A1 shown in FIG. 2 as the target parking position. Here, the first parking position A1 is a parking position different from the second parking position A2 (that is, from the parking position used as the maintenance area), and is a parking position away from the second parking position A2, for example. Therefore, by parking the vehicle M determined not to require maintenance at the first parking position A1, it is possible to suppress interference with the maintenance of the vehicle M for which maintenance is necessary.

For example, it is assumed that a user parks a rental vehicle (including a shared car) rented from a rental company or another person at the parking lot PA. The parking lot management device 400 can determine whether or not to perform maintenance based on the vehicle information of the vehicle M returned to the parking lot PA in this way, and when maintenance is necessary, an environment for maintenance can be arranged. Accordingly, it is possible to perform maintenance on the vehicle M by using the free time after the vehicle is parked, and it is possible to smoothly deliver the vehicle M to the next user who intends to use the vehicle M. Therefore, the vehicle M can be effectively utilized.

In addition, the vehicle M determined to require maintenance may not be able to be parked at the second parking position A2 for reasons such as the second parking position A2 is full, or the like. In this case, the processor 426 sets either of the first parking position A1 described above or a third parking position A3 shown in FIG. 2 as the target parking position, for example. Here, the third parking position A3 is a parking position different from the first parking position A1 and the second parking position A2, and is a parking position closer to the second parking position A2 than the first parking position A1, for example. For example, in the parking lot PA, a parking space PS for temporary standby is provided as the third parking position A3 in the vicinity of the second parking position A2.

For example, when the vehicle M determined to require maintenance cannot be parked at the second parking position A2, if the vehicle M can be parked at the third parking position A3, the processor 426 sets the third parking position A3 as the target parking position. As a result, even when the vehicle M determined to require maintenance cannot be parked at the second parking position A2, by parking the vehicle M at the third parking position A3 until the first parking position A1 becomes available, the vehicle M can be prepared for maintenance at the third parking position A3.

Meanwhile, when the vehicle M determined to require maintenance cannot be parked at the second parking position. A2 nor the third parking position A3, the processor 426 sets the first parking position A1 as the target parking position. As a result, even when the vehicle M determined to require maintenance cannot be parked at the second parking position A2 nor the third parking position A3, the vehicle M can be parked at the first parking position A1. In addition, a new parking position may be re-set.

Then, after setting the first parking position A1 and the third parking position A3 as the target accommodation positions for the vehicle M determined to require maintenance, the processor 426 sets the second parking position A2 as the target accommodation position when the vehicle M can be parked at the second parking position A2. As a result, the vehicle M determined to require maintenance can be moved to the second parking position A2.

As described above, when the vehicle M determined to require maintenance cannot be parked at the second parking position A2, by having the vehicle M temporarily wait at the third parking position A3 which is closer to the second parking position A2 than the first parking position A1, it is possible to get to the second parking position A2 in a short time when it is possible to park at the second parking position A2, and it is thus possible to improve a maintenance efficiency.

Further, when the maintenance of the vehicle M is completed, the processor 426 sets either of the first parking position A1 or the third parking position A3 as the target accommodation position. For example, when the vehicle M for which maintenance is completed can be parked at the first parking position A1, the processor 426 sets the first parking position A1 as the target parking position, and when the vehicle M for which maintenance is completed cannot be parked at the first parking position A1, the processor 426 sets the third parking position A3 as the target parking position. In addition, a new fourth parking position may be set. Here, the fourth parking position is a parking position different from any of the first parking position A1, the second parking position A2, and the third parking position A3. The fourth parking position may be a parking position where the vehicle M for which maintenance is completed is temporarily parked, such as the third parking position A3 or the like, or may be a parking position where the vehicle M can be continuously parked (for example, until exiting the parking lot). As a result, the vehicle M for which maintenance is completed can be moved out from the second parking position A2, which is the maintenance area, to empty the second parking position A2, and another vehicle M can be parked at the second parking position A2.

In addition, it is desirable that when the vehicle M is a rental vehicle that can be used by unspecified and a plurality users, user permission is not required to perform maintenance, and on the other hand, when the vehicle M is a user vehicle owned by a specific user, user permission is required to perform maintenance. For example, in this case, the parking lot management device 400 determines whether the vehicle is a rental vehicle or a user vehicle based on the vehicle ID, and when it is determined that the vehicle is a user vehicle, the parking lot management device 400 transmits information for confirming whether or not to perform maintenance to the user terminal device 300. As a result, maintenance of the rental vehicle can be performed quickly, and maintenance of the user vehicle can be performed while respecting the intention of the user.

Further, the acquisition unit 422 can acquire vehicle information at the timing when the user gets off the vehicle M or when the vehicle M enters the parking lot PA. As a result, whether or not maintenance is necessary can be determined immediately.

Further, after the vehicle M has entered the parking lot PA, even when it is determined that the maintenance of the vehicle M is unnecessary, the determination unit 424 can check whether or not maintenance is necessary at regular intervals, and when maintenance is necessary, the target parking position can be changed from the first parking position A1 to the second parking position A2, As a result, whether or not maintenance is necessary can be accurately determined.

When the target parking position of the vehicle M is set as described above, the processor 426 searches for a suitable route to the target parking position with reference to the parking lot map information 442 and the like, and transmits the searched route to the vehicle M using the communication unit 410.

In the vehicle M that receives the route, the action plan generation unit 130 generates a target track based on the route. The action control unit 140 controls the vehicle M to act according to the action plan generated by the action plan generation unit 130, and parks the vehicle M in the parking space PS.

### Processing Flow

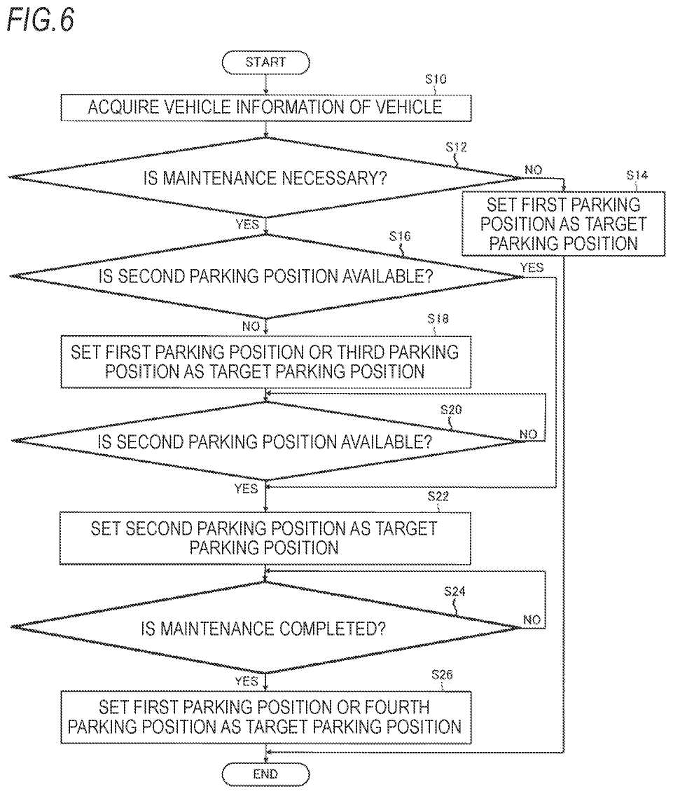

Hereinafter, a series of processing flows of the parking lot management device 400 will be described with reference to FIG. 6. The processes illustrated in FIG. 6 may be repeated. at a predetermined cycle.

First, the acquisition unit 422 acquires the vehicle information regarding the status of the vehicle M parked in the parking lot PA via the communication unit 410, for example, at the timing when the vehicle M enters the parking lot PA (Step S10). Based on the vehicle information acquired by the acquisition unit 422, the determination unit 424 determines whether or not maintenance of the vehicle M is necessary (Step S12). The processor 426 sets a target parking position of the vehicle M based on the determination result by the determination unit 424. Here, when maintenance is unnecessary, the processor 426 sets the first parking position as the target parking position (Step S14), and when maintenance is necessary, the processor 426 determines whether or not it is possible to park at the second parking position (Step S16). In addition, after the vehicle M has entered the parking lot PA, even when it is determined that the maintenance of the vehicle M is unnecessary, the determination unit 424 can check whether or not maintenance is necessary at regular intervals, and when maintenance is necessary, the target parking position can be changed from the first parking position A1 to the second parking position A2.

When the vehicle M can be parked at the second parking position (YES in Step S16), the processor 426 shifts to the process in Step S22. On the other hand, when the vehicle M cannot park at the second parking position (NO in Step S16), the processor 426 sets either of the first parking position or the third parking position as the target accommodation position (Step S18). Then, it is determined whether the vehicle M can be parked at the second parking position (Step S20), When the vehicle M cannot be parked at the second parking position (NO in Step S20), it is waited until the vehicle M can be parked at the second parking position.

Then, when the vehicle M can be parked at the second parking position (YES in Step S20), the processor 426 sets the second parking position as the target parking position (Step S22). Then, the processor 426 waits for the maintenance of the vehicle M to be completed (NO in Step S24), and when the maintenance of the vehicle M is completed (YES in Step S24), either of the first parking position or the new fourth parking position is set as the target parking position (Step S26).

When the vehicle M is a user vehicle owned by a specific user, and when the second parking position is set as the target accommodation position, the processor 426 may transmit information for confirming whether or not to perform maintenance to the users terminal device 300 via the communication unit 410. Meanwhile, when the vehicle M is a rental vehicle, such confirmation is unnecessary.

As described above, the parking lot management device 400 sets the target parking position of the vehicle M according to whether or not maintenance is necessary. As a result, the parking lot management device 400 can park the vehicle M requiring maintenance at a parking position where maintenance can be performed, and arrange an environment for maintenance. Therefore, the vehicle M can be effectively used.

The embodiment described above exemplifies a situation where the vehicle is moved in the parking lot. However, the idea of the present invention is not limited to such an embodiment and is also applied to a moving body (for example, a robot) including a vehicle. That is, the present invention also includes a case where the target accommodation position is changed in the accommodation area for accommodating the so-called moving body. Under this idea, “parking” is extended to the concept of “stop” and the “parking lot management device” of the embodiment is extended to the concept of “accommodation area management device”.

Although the embodiment for carrying out the present invention is described above using the embodiment, the present invention is not limited to the embodiment and various modifications and substitutions can be made without departing from the gist of the present invention.

In addition, at least the following matters are described in this specification. The components and the like corresponding to those of the embodiment described above are shown in parentheses, but the present invention is not limited thereto.

(1) An accommodation area management device (parking lot management device 400) which manages an accommodation area (parking lot PA) for accommodating a moving body (vehicle M) and stops the moving body at a predetermined accommodation position (parking space PS) in the accommodation area, including,
an acquisition unit (acquisition unit 422) that acquires moving body information regarding a status of the moving body,
a determination unit (determination unit 424) that determines whether or not maintenance of the moving body is necessary based on the moving body information acquired by the acquisition unit, and
a processor (processor 426) that sets a target accommodation position of the moving body based on the determination result by the determination unit,
in which,
when the maintenance of the moving body is unnecessary, the processor sets a first accommodation position (first parking position A1) as the target accommodation position, and when the maintenance of the moving body is necessary, the processor sets a second accommodation position (second parking position A2) as the target accommodation position.

According to (1), since the target accommodation position can be set according to whether or not maintenance of the moving body is required, the moving body can be effectively utilized.

(2) The accommodation area management device according to (1), in which,
when the moving body cannot be stopped at the second accommodation position, the processor sets either of the first accommodation position or a third accommodation position (third parking position A3) as the target accommodation position.

According to (2), even when the moving body cannot be stopped at the second accommodation position, the moving body can be prepared for maintenance at the first accommodation position or the third accommodation position.

(3) The accommodation area management device according to (2), in which,
after setting the first accommodation position or the third accommodation position as the target accommodation position, when the moving body can be stopped at the second accommodation position, the processor sets the second accommodation position as the target accommodation position.

According to (3), after setting the first accommodation position or the third accommodation position as the target accommodation position, when the moving body can be stopped at the second accommodation position, since the second accommodation position is set as the target accommodation position, the moving body can be moved to the second accommodation position and arrange an environment for maintenance.

(4) The accommodation area management device according to (2) or (3), in which
the third accommodation position is closer to the second accommodation position than the first accommodation position.

According to (4), since the third accommodation position is closer to the second accommodation position than the first accommodation position, when it becomes possible to stop at the second accommodation position, it is possible to get to the second accommodation position in a short time, thereby improving maintenance efficiency.

(5) The accommodation area management device according to any one of (1) to (4), in which,
when the maintenance of the moving body is completed, the processor sets either of the first accommodation position or a new fourth accommodation position as the target accommodation position.

According to (5), it is possible to move the moving body for which maintenance is completed out of the second accommodation position and have another vehicle stopped at the second accommodation position.

(6) The accommodation area management device according to any one of (1) to (5), in which,
when the moving body is a rental moving body that can be used by unspecified and a plurality users and used for renting, user permission is not required to perform maintenance, and when the moving body is a user moving body owned by a specific user, user permission is required to perform maintenance.

According to (6), it is possible to quickly perform maintenance on the rental moving body, and it is possible to perform maintenance on the user moving body while respecting the intention of the user.

(7) The accommodation area management device according to any one of (1) to (6), in which,
the acquisition unit acquires the moving body information at the timing when the moving body enters the accommodation area.

According to (7), it is possible to quickly determine whether or not maintenance is required.

(8) The accommodation area management device according to any one of (1) to (7), in which,
after the moving body entered the accommodation area, even when it is determined that maintenance of the moving body is unnecessary, the determination unit checks whether or not maintenance is necessary at regular intervals, and when maintenance is necessary, the target accommodation position is changed from the first accommodation position to the second accommodation position.

According to (8), whether or not maintenance is necessary can be accurately determined.

What is claimed is:

1. An accommodation area management device configured to manage an accommodation area for accommodating a moving body and configured to stop the moving body at a predetermined accommodation position in the accommodation area, comprising:
an acquisition unit configured to acquire moving body information regarding a status of the moving body;
a determination unit configured to determine whether or not maintenance of the moving body is necessary based on the moving body information acquired by the acquisition unit; and
a processor configured to set a target accommodation position of the moving body based on the determination result by the determination unit, wherein,
when the maintenance of the moving body is unnecessary, the processor sets a first accommodation position as the target accommodation position, and when the maintenance of the moving body is necessary, the processor sets a second accommodation position as the target accommodation position.

2. The accommodation area management device according to claim 1, wherein,
when the moving body cannot be stopped at the second accommodation position, the processor sets either of the first accommodation position or a third accommodation position as the target accommodation position.

3. The accommodation area management device according to claim 2, wherein,
after setting the first accommodation position or the third accommodation position as the target accommodation position, when the moving body can he stopped at the second accommodation position, the processor sets the second accommodation position as the target accommodation position.

4. The accommodation area management device according to claim 2, wherein
the third accommodation position is closer to the second accommodation position than the first accommodation position.

5. The accommodation area management device according to claim 1, wherein,
when the maintenance of the moving body is completed, the processor sets either of the first accommodation position or a new fourth accommodation position as the target accommodation position.

6. The accommodation area management device according to claim 1, wherein,
when the moving body is a rental moving body that can be used by unspecified and a plurality users and used for renting, user permission is not required to perform maintenance, and when the moving body is a user moving body owned by a specific user, user permission is required to perform maintenance.

7. The accommodation area management device according to claim 1, wherein
the acquisition unit acquires the moving body information at the timing when the moving body enters the accommodation area.

8. The accommodation area management device according to claim 1, wherein,
after the moving body entered the accommodation area, even when it is determined that maintenance of the moving body is unnecessary, the determination unit checks whether or not maintenance is necessary at regular intervals, and when maintenance is necessary, the target accommodation position is changed from the first accommodation position to the second accommodation position.
